(19) United States
(12) Patent Application Publication
(10) Pub. No.: US 2020/0108730 A1
(43) Pub. Date: Apr. 9, 2020

(54) DIAGNOSIS APPARATUS, DIAGNOSIS METHOD, AND PROGRAM

(71) Applicant: HONDA MOTOR CO., LTD., Tokyo (JP)

(72) Inventors: Taisuke Tsurutani, Wako-shi (JP); Taisuke Kurachi, Wako-shi (JP)

(21) Appl. No.: 16/585,044

(22) Filed: Sep. 27, 2019

(30) Foreign Application Priority Data
Oct. 5, 2018 (JP) 2018-190240

(51) Int. Cl. B60L 53/62; B60L 58/16

(52) U.S. Cl. CPC B60L 53/62; B60L 58/16

(57) ABSTRACT

A diagnosis apparatus includes: an estimation part that estimates a deterioration state of a secondary battery based on an output of a sensor which is attached to the secondary battery that supplies electric power for driving a vehicle to travel; a derivation part that derives an index value indicating validness of data used for estimation of the deterioration state; an output part that outputs information; and an approval part that allows the output part to output information requesting an approval for performing a specific charging/discharging operation using an external charger which supplies electric power to the secondary battery in a case where the index value that is derived by the derivation part is equal to or smaller than a predetermined value.

### CROSS-REFERENCE TO RELATED APPLICATION

Priority is claimed on Japanese Patent Application No. 2018-190240, filed on Oct. 5, 2018, the contents of which are incorporated herein by reference.

### BACKGROUND

### Field of the Invention

The present invention relates to a diagnosis apparatus, a diagnosis method, and a program.

### Background

Recently, an electric vehicle that supplies electric power of a rechargeable secondary battery to a motor and travels using only the motor, and a hybrid electric vehicle that includes an engine and a motor for traveling and travels using power of at least one of the engine and the motor are widely used. In the electric vehicle and the hybrid electric vehicle, it is known that a value indicating a deterioration state of a battery (SOH: State of health) is displayed (for example, refer to Japanese Unexamined Patent Application, First Publication No. 2009-208484).

### SUMMARY

However, in the technology of the related art, there may be cases in which the accuracy of estimation of the deterioration state of a secondary battery is low.

An object of an aspect of the present invention is to improve the accuracy of estimation of the deterioration state of a secondary battery.

A diagnosis apparatus, a diagnosis method, and a program according to aspects of the present invention employ the following configurations.

(1): A diagnosis apparatus according to an aspect of the present invention includes: an estimation part that estimates a deterioration state of a secondary battery based on an output of a sensor which is attached to the secondary battery that supplies electric power for driving a vehicle to travel; a derivation part that derives an index value indicating validness of data used for estimation of the deterioration state; an output part that outputs information; and an approval part that allows the output part to output information requesting an approval for performing a specific charging/discharging operation using an external charger which supplies electric power to the secondary battery in a case where the index value that is derived by the derivation part is equal to or smaller than a predetermined value.

(2): The diagnosis apparatus according to the aspect (1) described above may further include an acceptance part that accepts a user's input, wherein the approval part may perform a process for performing the specific charging/discharging operation based on the user's input that is accepted by the acceptance part.

(3): In the diagnosis apparatus according to the aspect (1) or (2) described above, the derivation part may derive the index value based on a number of times of acquiring the output of the sensor as the data used for estimation performed by the estimation part.

(4): In the diagnosis apparatus according to any one of the aspects (1) to (3) described above, the derivation part may derive the index value based on an amount of change in a charging rate of the secondary battery changed in accordance with charging/discharging of the secondary battery.

(5): The diagnosis apparatus according to any one of the aspects (1) to (4) described above may further include an acquisition part that acquires information indicating a parking status of the vehicle, wherein the approval part may allow the output part to output the information requesting the approval in a case where the parking status indicated by the information that is acquired by the acquisition part satisfies a predetermined condition.

(6): In the diagnosis apparatus according to any one of the aspects (1) to (5) described above, the approval part may allow the output part to output the index value and information indicating the deterioration state of the secondary battery when allowing the output part to output the information requesting the approval.

(7): A diagnosis method according to another aspect of the present invention is a diagnosis method performed using a computer mounted on a vehicle, the diagnosis method including: estimating a deterioration state of a secondary battery based on an output of a sensor which is attached to the secondary battery that supplies electric power for driving the vehicle to travel; deriving an index value indicating validness of data used for estimation of the deterioration state; and allowing an output part to output information requesting an approval for performing a specific charging/discharging operation using an external charger which supplies electric power to the secondary battery in a case where the derived index value is equal to or smaller than a predetermined value.

(8): Still another aspect of the present invention is a non-transitory computer-readable recording medium including a program causing a computer mounted on a vehicle to execute: estimating a deterioration state of a secondary battery based on an output of a sensor which is attached to the secondary battery that supplies electric power for driving the vehicle to travel; deriving an index value indicating validness of data used for estimation of the deterioration state; and allowing an output part to output information requesting an approval for performing a specific charging/discharging operation using an external charger which supplies electric power to the secondary battery in a case where the derived index value is equal to or smaller than a predetermined value.

According to the aspects (1) to (8) described above, it is possible to improve the accuracy of estimation of the deterioration state of the secondary battery.

### BRIEF DESCRIPTION OF THE DRAWINGS

FIG. 1 is an explanatory view showing an example of a configuration of a diagnosis system.

FIG. 2 is an explanatory view showing a configuration of a vehicle cabin of a vehicle.

FIG. 3 is an explanatory view showing a diagnosis apparatus and surrounding constituent elements.

FIG. 4 is a flowchart showing an example of a process of requesting a capacity learning operation that is performed by the diagnosis apparatus.

FIG. 5 is a sequence view showing an example when the capacity learning operation is performed.

FIG. 6 is an explanatory view showing an example of a reliability identification table used for identifying the reliability from a sum of the number of times of capacity learning.

FIG. 7 is an explanatory view showing an example of a display screen relating to a deterioration state of a battery.

FIG. 8 is an explanatory view showing Modified Example 1 of the present embodiment.

### DESCRIPTION OF EMBODIMENTS

Hereinafter, a diagnosis apparatus, a diagnosis method, and a program according to embodiments of the present invention will be described with reference to the drawings. In the following description, a vehicle 10 is an electric vehicle. However, the vehicle 10, for example, may be any vehicle such as a hybrid vehicle or a fuel cell vehicle in which a secondary battery that supplies electric power for traveling is mounted.

### EMBODIMENT

### [Vehicle 10]

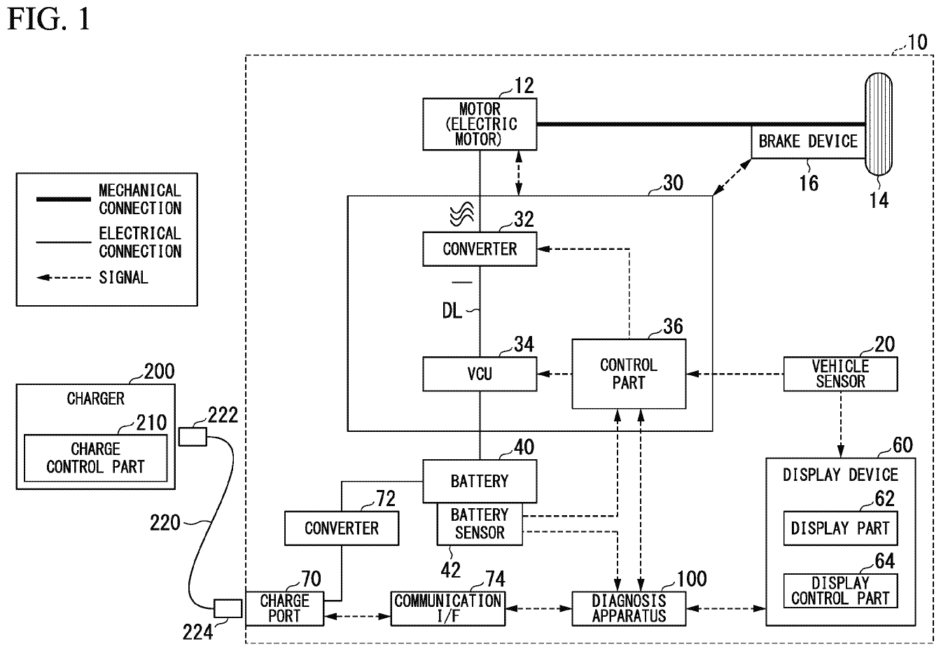

FIG. 1 is an explanatory view showing an example of a configuration of a diagnosis system. As shown in FIG. 1, the diagnosis system includes a vehicle 10 and a charger 200. The vehicle 10, for example, includes a motor 12, a driving wheel 14, a brake device 16, a vehicle sensor 20, a PCU (Power Control Unit) 30, a battery 40, a battery sensor 42, a display device 60, a charge port 70, a converter 72, and a diagnosis apparatus 100.

The motor 12, for example, is a three-phase AC electric motor. A rotor included in the motor 12 is connected to the driving wheel 14. The motor 12 outputs power to the driving wheel 14 using a supplied electric power. The motor 12 generates power using kinetic energy of the vehicle at the time of decelerating the vehicle.

The brake device 16, for example, includes a brake caliper, a cylinder that transmits a hydraulic pressure to the brake caliper, and an electric motor that generates hydraulic pressure in the cylinder. The brake device 16 may include a mechanism that transmits a hydraulic pressure generated in accordance with an operation on a brake pedal to the cylinder through a master cylinder as a backup. The brake device 16 is not limited to the configuration described above and may be an electronic control-type hydraulic brake device that transmits a hydraulic pressure of the master cylinder to the cylinder.

The vehicle sensor 20 includes an acceleration opening degree sensor, a vehicle speed sensor, and a brake depression amount sensor. The acceleration opening degree sensor is attached to an acceleration pedal as an example of an operator accepting an acceleration command from a driver, detects the amount of operation of the acceleration pedal, and outputs the detected amount of operation to the control part 36 as a degree of acceleration opening. The vehicle speed sensor, for example, includes vehicle wheel speed sensors attached to vehicle wheels and a speed calculator, derives a speed of the vehicle (vehicle speed) by combining vehicle wheel speeds detected by the vehicle wheel speed sensors, and outputs the derived speed to the control part 36 and the display device 60. The brake depression amount sensor is attached to the brake pedal. The brake depression amount sensor detects the amount of operation of the brake pedal and outputs the detected amount of operation of the brake pedal to the control part 36 as the amount of depression of the brake.

The PCU 30, for example, includes a converter 32, a VCU (Voltage Control Unit) 34, and a control part 36. An integrated configuration of such constituent elements as the PCU 30 is merely an example, and such constituent elements may be arranged in a distributed manner.

The converter 32, for example, is an AC-DC converter. A DC-side terminal of the converter 32 is connected to a DC link DL. The battery 40 is connected to the DC link DL through the VCU 34. The converter 32 converts an AC generated by the motor 12 into a DC and outputs the DC to the DC link DL.

The VCU 34, for example, is a DC-DC converter. The VCU 34 boosts electric power supplied from the battery 40 and outputs the boosted electric power to the DC link DL.

The control part 36, for example, includes a motor control part, a brake control part, and a battery VCU control part. The motor control part, the brake control part, and the battery VCU control part may be replaced by separate control devices which are, for example, a control apparatus such as a motor ECU, a control apparatus such as a brake ECU, and a control apparatus such as a battery ECU.

The motor control part controls the motor 12 on the basis of an output of the vehicle sensor 20. The brake control part controls the brake device 16 on the basis of an output of the vehicle sensor 20. The battery VCU control part calculates a SOC (State Of Charge; battery charge rate) of the battery 40 on the basis of an output of the battery sensor 42 attached to the battery 40 and outputs the calculated SOC to the VCU 34 and the diagnosis apparatus 100. The VCU 34 raises a voltage of the DC link DL in accordance with a command from the battery VCU control part.

The battery 40, for example, is a secondary battery such as a lithium ion battery. The battery 40 accumulates electric power introduced from the charger 200 disposed outside the vehicle 10 and discharges for traveling of the vehicle 10. The battery sensor 42, for example, includes a current sensor, a voltage sensor, and a temperature sensor. The battery sensor 42, for example, detects a current value, a voltage value, and a temperature of the battery 40.

The battery sensor 42 outputs the current value, the voltage value, the temperature, and the like that have been detected to the control part 36 and the diagnosis apparatus 100.

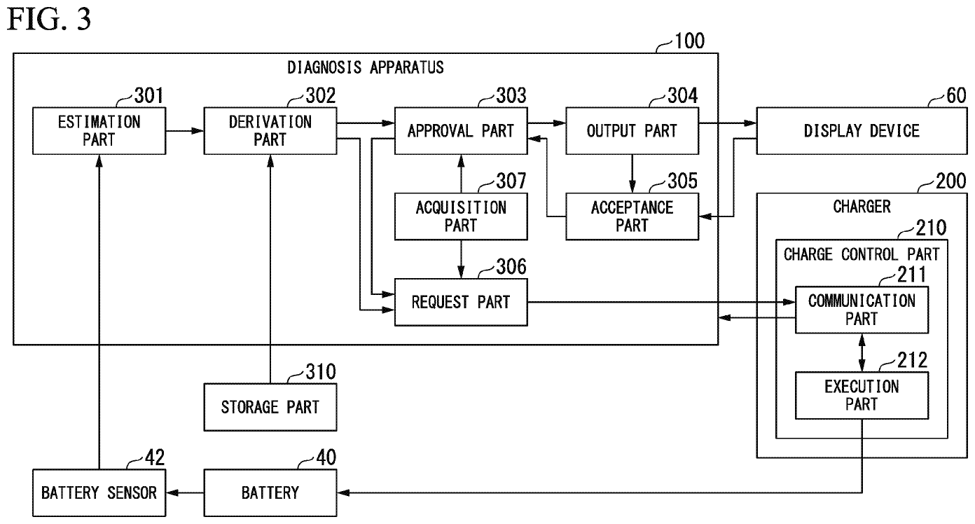

The diagnosis apparatus 100 estimates a deterioration state (for example, SOH: State Of Health) of the battery 40 on the basis of the output of the battery sensor 42. In a case where the reliability of data (for example, ΔSOC) used for estimation of the deterioration state is equal to or smaller than a predetermined value, the diagnosis apparatus 100 requests a charge control part 210 of the charger 200 to perform a specific charging/discharging operation through a communication I/F 74 in accordance with a user's approval. The communication I/F 74 functions as an interface between the diagnosis apparatus 100 and the charge control part 210. The diagnosis apparatus 100 may be provided integrally with the control part 36. Details of the diagnosis apparatus 100 will be described later with reference to FIG. 3.

The display device 60, for example, includes a display part 62 and a display control part 64. The display part 62 displays information in accordance with a control of the display control part 64. The display control part 64 allows the display part 62 to display information relating to the battery 40 in accordance with information output from the vehicle sensor 20, the control part 36, and the diagnosis apparatus 100. The display control part 64 allows the display part 62 to display a vehicle speed and the like output from the vehicle sensor 20.

The charge port 70 is provided facing the outside of a vehicle body of the vehicle 10. The charge port 70 is connected to the charger 200 through a charge cable 220. The charge cable 220 includes a first plug 222 and a second plug 224. The first plug 222 is connected to the charger 200. The second plug 224 is connected to the charge port 70. Electricity supplied from the charger 200 is supplied to the charge port 70 through the charge cable 220.

The charge cable 220 includes a signal cable provided on an electric power cable. The signal cable relays a communication between the vehicle 10 and the charger 200. Accordingly, an electric power connector and a signal connector are provided on each of the first plug 222 and the second plug 224.

The converter 72 is provided between the battery 40 and the charge port 70. The converter 72 converts a current introduced from the charger 200 through the charge port 70, for example, an AC current into a DC current. The converter 72 outputs the converted DC current to the battery 40.

Next, the charger 200 will be described. The charger 200 includes the charge control part 210.

When a request for a specific charging/discharging operation is received from the diagnosis apparatus 100, the charge control part 210 performs charging/discharging in accordance with the specific charging/discharging operation for the battery 40. When the specific charging/discharging operation is completed, the charge control part 210 transmits a completion notification to the diagnosis apparatus 100.

In the present embodiment, the charge system of the battery 40 is a contact type in which the charge port 70 and the charger 200 are connected through the charge cable 220 but is not limited thereto. The charge system of the battery 40, for example, can be a non-contact type and, more specifically, can be a non-contact type in which charging is performed by magnetic coupling between a power transmission coil provided on the ground and a power reception coil connected to the battery.

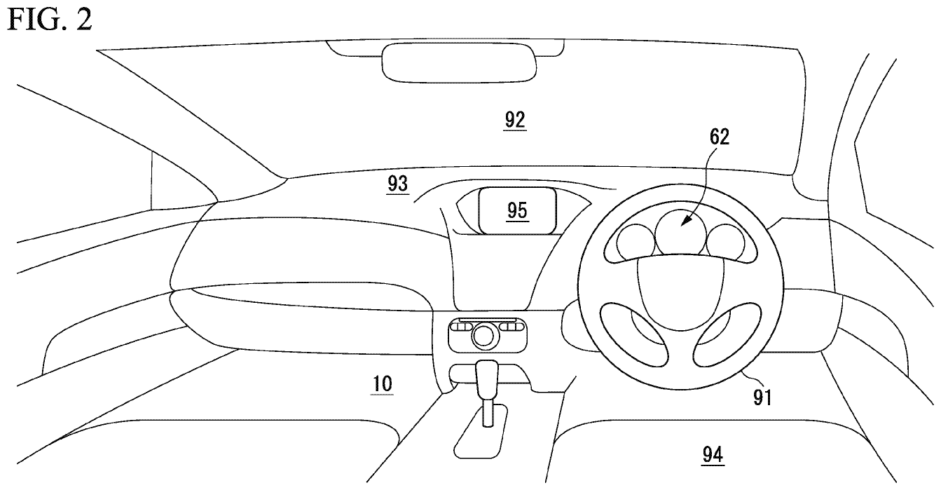

FIG. 2 is an explanatory view showing an example of a configuration of a vehicle cabin of the vehicle 10. As shown in FIG. 2, for example, a steering wheel 91 that controls the steering of the vehicle 10, a front windshield 92 that partitions the inside of the vehicle from the outside of the vehicle, and an instrument panel 93 are provided on the vehicle 10. The front windshield 92 is a member having a light transmission property.

The display part 62 of the display device 60 is provided near the front of a driver's seat 94 on the instrument panel 93 inside the vehicle cabin. The display part 62 is arranged to be visually recognizable by a driver through a gap of the steering wheel 91 or over the steering wheel 91. A second display device 95 that is different from the display device 60 is provided at the middle of the instrument panel 93.

The second display device 95, for example, displays an image corresponding to a navigation process performed by a navigation device (not shown in the drawing) provided on the vehicle 10 or displays a video or the like of a partner in a video telephone call. The second display device 95 may display a television program, play back a DVD, or display a content such as a downloaded movie.

### [Diagnosis Apparatus 100]

Next, the diagnosis apparatus 100 and surrounding constituent elements of the diagnosis apparatus 100 will be described with reference to FIG. 3. FIG. 3 is an explanatory view showing the diagnosis apparatus 100 and the surrounding constituent elements. As shown in FIG. 3, the diagnosis apparatus 100 includes an estimation part 301, a derivation part 302, an approval part 303, an output part 304, an acceptance part 305, a request part 306, and an acquisition part 307. Such functional parts are realized by the diagnosis apparatus 100 executing a program.

The diagnosis apparatus 100, for example, is realized by a hardware processor such as a CPU (Central Processing Unit) executing a program (software). Some or all of such constituent elements may be realized by hardware (a circuit part; including circuitry) such as a LSI (Large Scale Integration), an ASIC (Application Specific Integrated Circuit), a FPGA (Field-Programmable Gate Array), or a GPU (Graphics Processing Unit), or may be realized by software and hardware in cooperation.

The estimation part 301 estimates a deterioration state of the battery 40 on the basis of an output of a sensor (for example, the battery sensor 42) which is attached to a secondary battery (for example, the battery 40) that supplies electric power for driving the vehicle 10 to travel. The battery sensor 42 can detect the amount of current (Ah) that flows through the battery 40 or an output voltage of the battery 40.

The deterioration state, for example, is a value estimated using an amount of change ΔAh in the charging/discharging amount Ah (ampere-hour) and an amount of change (ΔSOC) in the ratio (amount of charging: SOC) of a remaining capacity to a full-charge capacity. More specifically, the amount of change (ΔAh) in the charging/discharging amount, for example, is a value calculated using amounts of current flowing through the battery 40 detected at different pre-determined times using the battery sensor 42. The amount of change (ΔSOC) in the SOC is a value calculated using an SOC at each time calculated using output voltages of the battery 40 detected at different pre-determined times using the battery sensor 42.

The estimation part 301 estimates the deterioration state of the battery 40 using a full charge capacity (=ΔAh/ΔSOC) that is acquired by dividing the amount of change (ΔAh) in the charging/discharging amount by the amount of change (ΔSOC) in the charging state. The deterioration state of the battery 40 is a value that is calculated with higher accuracy in a case of charging/discharging having a large ΔSOC than in a case of charging/discharging having a small ΔSOC. The amounts ΔAh and ΔSOC, for example, may be calculated by either the diagnosis apparatus 100 or the control part 36.

The derivation part 302 derives an index value indicating validness of data used for estimation of the deterioration state. The data used for estimation of the deterioration state, for example, includes data indicating an amount of change (ΔSOC) in the charging rate of the battery 40. The validness of data, for example, is the reliability of the data. For this reason, the index value, for example, corresponds to a value indicating the reliability with respect to the deterioration state of the battery 40. The index value is a value corresponding to an amount of change (ΔSOC) in the charging rate (SOC) of the battery 40 changed in accordance with charging/discharging during traveling of the vehicle 10.

The derivation part 302 derives the index value on the basis of the amount of change (ΔSOC) in the charging rate of the battery 40 changed in accordance with charging/discharging of the battery 40. The derivation part 302 derives the index value on the basis of the number of times of acquiring an output of the battery sensor 42 (the number of times of capacity learning) as data used for estimation by the estimation part 301. The output of the battery sensor 42 described here, for example, is an output of data indicating that charging/discharging in which the amount of change (ΔSOC) in the SOC is equal to or larger than a predetermined amount has been performed during traveling of the vehicle 10. Hereinafter, performing the charging/discharging in which an amount of change (ΔSOC) in the SOC is equal to or larger than a predetermined amount (charging/discharging having a large ΔSOC) will be referred to as “capacity learning”, and the number of times of performing capacity learning will be referred to as the “number of times of capacity learning.”

The derivation part 302 derives the index value on the basis of the number of times of capacity learning during traveling of the vehicle 10. The index value, for example, is a value corresponding to the number of times of capacity learning within a predetermined period. Specifically, as the index value, for example, a small value is associated with a small number of times of capacity learning, and a large value is associated with a large number of times of capacity learning.

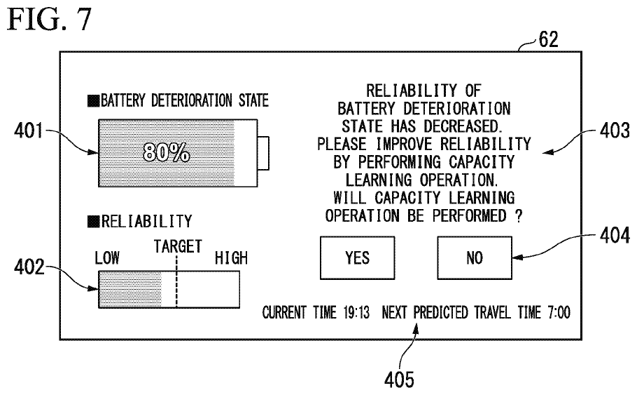

The storage part 310 stores, for example, a history of capacity learning data including information indicating that a capacity learning has been performed and information indicating a date and time and a place at which each capacity learning has been performed. The storage part 310 stores a table (refer to FIG. 7) in which the number of times of capacity learning and an index value (a value indicating reliability) are associated with each other. For example, the derivation part 302 calculates the number of times of capacity learning within a predetermined period by referring to the storage part 310 and derives an index value corresponding to the calculated number of times of capacity learning by referring to the table stored in the storage part 310. The storage part 310, for example, is realized by a storage device such as a flash memory.

The index value is not limited to a value corresponding to the number of times of capacity learning. For example, the index value may be a value corresponding to a value (for example, a sum of squares of ΔSOC) acquired from an amount of change (ΔSOC) of the charging rate of the battery 40 changed in accordance with charging/discharging of the battery 40. Specifically, the index value, for example, may be a value corresponding to a value (a sum of squares of ΔSOC) acquired from the latest capacity learning. Thereby, the ΔSOC can be made marked, and therefore, even when a sum of squares of ΔSOC is used, it is possible to estimate the deterioration state of the battery 40 with high accuracy.

The index value, for example, may be a value corresponding to the number of times of specific charging/discharging operations (capacity learning operations) performed by the charger 200. The capacity learning operation is an operation of performing charging/discharging having a large amount of change (ΔSOC) in the SOC that is performed by the charger 200 when the vehicle stops for a predetermined time. The index value may be a value corresponding to the number of times of capacity learning within a predetermined period.

In a case where the index value acquired by the derivation part 302 is equal to or smaller than a predetermined value (threshold value), the approval part 303 allows the output part 304 to output information requesting an approval for performing a capacity learning operation using an external charger (the charger 200) which supplies electric power to the battery 40 (hereinafter, referred to as “an approval for a capacity learning operation”). The information output from the output part 304, for example, is information urging the execution of the capacity learning operation and is displayed on the display device 60.

When allowing the output part to output the information for requesting an approval for a capacity learning operation, the approval part 303 gives a notification of performing a capacity learning operation using the charger 200 by using an image or speech. For example, in a case where the number of times of capacity learning within a predetermined period is equal to smaller than a threshold value, the approval part 303 allows the output part 304 to output information requesting an approval for a capacity learning operation. In a case where the index value is set to a value corresponding to a value (a sum of squares of ΔSOC) acquired from a capacity learning, the approval part 303 may allow the output part 304 to output information requesting an approval for a capacity learning operation in a case where the sum of squares of ΔSOC is equal to or smaller than the threshold value.

The acceptance part 305 accepts a user's input. The acceptance part 305 accepts whether a capacity learning operation is performed via a touch panel of the display part 62 of the display device 60. The approval part 303 performs a process for performing a capacity learning operation on the basis of the user's input accepted by the acceptance part 305. Specifically, in a case where there is an input (approval) indicating that a capacity learning operation is performed via the acceptance part 305, the approval part 303 outputs information for performing a request of a capacity learning operation to the request part 306. In a case where there is an input indicating that a capacity learning operation is performed, the approval part 303, for example, may output reservation information for performing a capacity learning operation after a predetermined time to the request part 306.

The request part 306 requests the charger 200 that supplies electric power to the battery 40 to perform a capacity learning operation on the basis of the process of the approval part 303. In a case where the index value derived by the derivation part 302 is equal to or smaller than a predetermined value (threshold value), the request part 306 may request the charger 200 that supplies electric power to the battery 40 to perform a capacity learning operation regardless of presence/absence of an approval from the approval part 303.

For example, in a case where the number of times of capacity learning within a predetermined period is equal to or smaller than a predetermined value (threshold value), the request part 306 may request the charger 200 that supplies electric power to the battery 40 to perform a capacity learning operation regardless of presence/absence of an approval from the approval part 303. In a case where the index value is set to a value corresponding to a value (a sum of squares of ΔSOC) acquired from capacity learning, the request part 306 may request a capacity learning operation in a case where the sum of squares of ΔSOC is equal to or smaller than a threshold value.

The acquisition part 307 acquires information indicating a parking status of the vehicle 10. The acquisition part 307, for example, acquires information indicating a parking status of the vehicle 10 from a travel history of a navigation device provided on the vehicle 10 and the like. The information indicating a parking status, for example, includes position information indicating a parked position of the vehicle 10 and information of a parking time of the vehicle 10 predicted from the travel history.

In a case where a parking status indicated by the information acquired by the acquisition part 307 satisfies a predetermined condition, the approval part 303 allows the output part 304 to output information requesting an approval for a capacity learning operation.

The predetermined condition, for example, is a condition under which a charge time that is equal to or longer than a predetermined time (for example, 6 hours) can be secured. For example, the approval part 303 may determine whether or not a parking status of the vehicle 10 is under a predetermined condition by referring to the travel history.

In a case where the parking status indicated by the information acquired by the acquisition part 307 satisfies a predetermined condition, the request part 306 requests a capacity learning operation. Also in such a case, the request part 306 may request a capacity learning operation in a case where a user's approval is acquired via the approval part 303.

The charge control part 210 of the charger 200 includes a communication part 211 and an execution part 212. The communication part 211 receives a request for a capacity learning operation from the diagnosis apparatus 100 (the request part 306). In a case where a request for a capacity learning operation has been received by the communication part 211, the execution part 212 executes the capacity learning operation for the battery 40. For example, the capacity learning operation includes a state in which charging/discharging is performed for the battery 40 and a pause state in which predetermined charging/discharging is not performed. Specifically, the capacity learning operation is an operation in which charging/discharging (for example, discharging) is performed after the battery 40 comes into a stable state, and charging/discharging (for example, charging) is performed after a stable state is formed after discharging.

A capacity learning operation is performed by the charger 200, and thereby, the battery 40 is charged and discharged in accordance with the capacity learning operation. When the capacity learning operation is completed, the execution part 212 outputs information indicating the completion of the learning operation to the communication part 211. When the information indicating the completion of the learning operation is received from the execution part 212, the communication part 211 transmits notification information indicating the completion of the capacity learning operation to the diagnosis apparatus 100. By performing such a capacity learning operation, the diagnosis apparatus 100 can acquire data having a large amount of change (ΔSOC) in the SOC and can calculate the deterioration state of the battery 40 with high accuracy.

When information for requesting an approval for a capacity learning operation is output by the output part 304, the approval part 303 allows the output part 304 to output information indicating a deterioration state of the battery 40 and an index value. When such information is received from the output part 304, the display device 60 (the display control part 64) allows the display part 62 to display a notification image urging the execution of a capacity learning operation, a notification image indicating a deterioration state of the battery 40, and a notification image indicating an index value (reliability). A timing at which the display part 62 is allowed to display such images may be an arbitrary timing at which an operation for displaying such images is accepted from a user, a timing at which the deterioration state of the battery 40 becomes a predetermined value or less, or a timing at which the index value becomes a predetermined value or less.

### [Process of Requesting Capacity Learning Operation]

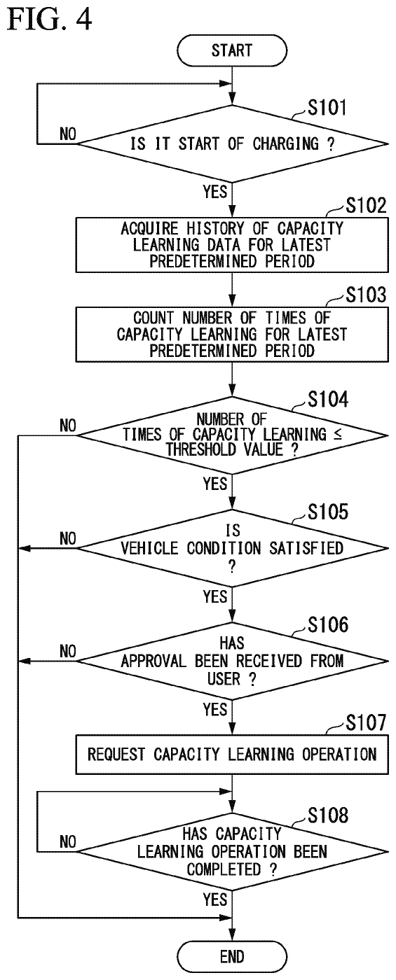

Next, the process of requesting a capacity learning operation performed in accordance with the number of times of capacity learning will be described with reference to FIG. 4. FIG. 4 is a flowchart showing an example of the process of requesting a capacity learning operation that is performed by the diagnosis apparatus 100.

In FIG. 4, the diagnosis apparatus 100 determines whether it is the start of charging or not (Step S101). The start of charging is a status in which start of charging is available. For example, the start of charging is detection of a connection between the charge port 70 and the charger 200 using the charge cable 220, detection of the vehicle 10 being positioned near the charger 200 using the position information.

The diagnosis apparatus 100 waits until the start of charging (Step S101: No). In a case where the start of charging is determined, the diagnosis apparatus 100 acquires a history of capacity learning data for a latest predetermined period (Step S102). Then, the diagnosis apparatus 100 counts (sums) the number of times of capacity learning of the latest predetermined period (for example, the latest one month) using the acquired history of capacity learning data (Step S103). The sum of the numbers of times of capacity learning, for example, corresponds to the reliability of data used for estimation of the deterioration state of the battery 40.

Next, the diagnosis apparatus 100 determines whether or not the number of times of capacity learning is equal to or smaller than a threshold value (for example, three) (Step S104). In a case where the number of times of capacity learning is not equal to or smaller than the threshold value (Step S104: No), that is, in a case where it is recognized that there is a predetermined reliability in the data used for estimation of the deterioration state, the diagnosis apparatus 100 ends a series of processes.

In a case where the number of times of capacity learning is equal to or smaller than the threshold value (Step S104: Yes), that is, in a case where it is not recognized that there is a predetermined reliability in the data used for estimation of the deterioration state, the diagnosis apparatus 100 determines whether or not a vehicle condition (predetermined condition) is satisfied (Step S105). The vehicle condition, for example, is a condition in which it is predicted that a capacity learning operation can be performed and, for example, is a condition in which the vehicle 10 stops at a house, and it is predicted that a predetermined time (for example, 6 hours) can be secured until the next travel.

In a case where it is determined that the vehicle condition is not satisfied (Step S105: No), that is, for example, in a case where it is determined that a predetermined time for performing a capacity learning operation cannot be secured, the diagnosis apparatus 100 ends a series of the processes. On the other hand, in a case where it is determined that the vehicle condition is satisfied (Step S105: Yes), that is, for example, in a case where it is determined that a predetermined time for performing a capacity learning operation can be secured, the diagnosis apparatus 100 displays a screen for accepting an approval for performing a capacity learning operation from a user and determines whether or not the approval for performing a capacity learning operation has been accepted from the user (Step S106).

In a case where an approval for performing a capacity learning operation has not been accepted from the user (Step S106: No), the diagnosis apparatus 100 ends a series of the processes. On the other hand, in a case where an approval for performing a capacity learning operation has been accepted from the user (Step S106: Yes), the diagnosis apparatus 100 requests the charger 200 to perform a capacity learning operation (Step S107). Upon receiving this request, the charger 200 (the charge control part 210) performs a capacity learning operation.

Then, the diagnosis apparatus 100 determines whether or not the capacity learning operation has been completed (Step S108). The completion of the capacity learning operation, for example, is reception of a completion notification of the capacity learning operation from the charge control part 210. The diagnosis apparatus 100 waits until the capacity learning operation is completed (Step S108: No). On the other hand, when the capacity learning operation is completed (Step S108: Yes), the diagnosis apparatus 100 ends a series of the processes.

According to the process described above, the diagnosis apparatus 100 can perform a capacity learning operation in a case where the number of times of capacity learning is equal to or smaller than the threshold value, and therefore, the reliability of data used for estimating a deterioration state of the battery 40 can be improved. In the process described above, a capacity learning operation is performed in a case where the number of times of capacity learning for a latest predetermined period is equal to or smaller than the threshold value (Step S104: Yes) but is not limited thereto. For example, a capacity learning operation may be performed in a case where a sum of squares of ΔSOC of the latest capacity learning data is equal to or smaller than the threshold value. Also in such a case, the reliability of data used for estimation of the deterioration state of the battery 40 can be improved, and the deterioration state of the battery 40 can be estimated with high accuracy.

### [Flow at Time of Performing Capacity Learning Operation]

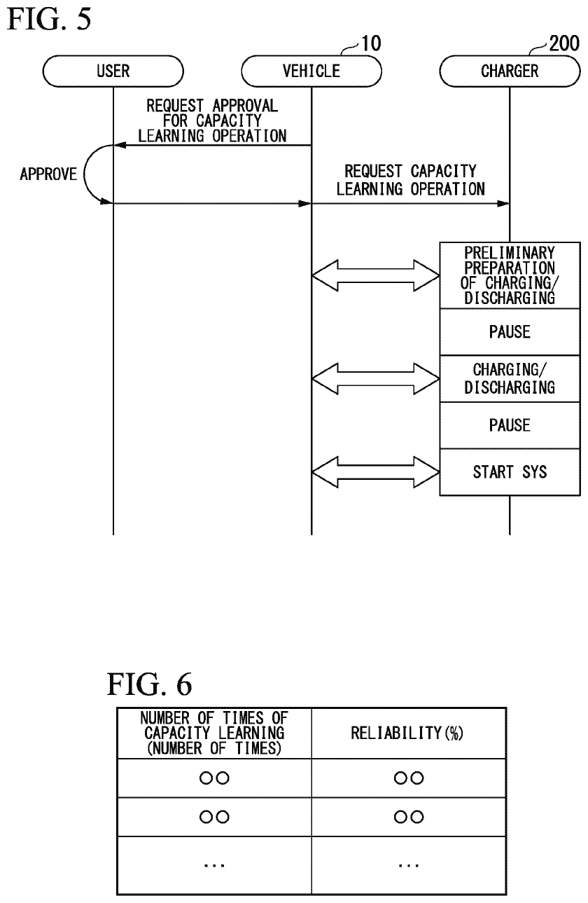

Next, the flow at the time of performing a capacity learning operation will be described with reference to FIG. 5. FIG. 5 is a sequence view showing an example when a capacity learning operation is performed. In FIG. 5, when the vehicle condition is satisfied, the vehicle 10 (the diagnosis apparatus 100) requests an approval for a capacity learning operation from a user. When an approval is received from the user, the vehicle 10 requests the charger 200 to perform a capacity learning operation. When a request for a capacity learning operation is received from the vehicle 10, the charger 200 (the charge control part 210) performs the capacity learning operation.

In the capacity learning operation, the charge control part 210 performs preliminary preparation of charging/discharging. The preliminary preparation of charging/discharging is, for example, performing charging/discharging (for example, discharging) such that the SOC becomes a first specified value. Before the charging/discharging in the preliminary preparation of charging/discharging, a pause period may be provided for stabilizing the battery 40. After performing the preliminary preparation of charging/discharging, the charge control part 210 pauses charging/discharging until a first pause period elapses in order to stabilize the battery 40. When the first pause period elapses, the charge control part 210 performs charging/discharging (for example, charging) until the SOC becomes a second specified value.

When charging/discharging is performed until the SOC becomes the second specified value, the charge control part 210 pauses charging/discharging until a second pause period elapses in order to stabilize the battery 40. When the second pause period elapses, the charge control part 210 starts a predetermined system and notifies the vehicle 10 (the diagnosis apparatus 100) that the capacity learning operation has been completed. In this way, the capacity learning operation is performed. When a completion notification indicating the completion of the capacity learning operation is received, the diagnosis apparatus 100 stores an indication that the learning operation has been performed and date and time at which the learning operation has been performed in a predetermined storage area (the storage part 310).

### [Relation Between Number of Times of Capacity Learning and Reliability]

Next, the relationship between the number of times of capacity learning and reliability will be described with reference to FIG. 6. FIG. 6 is an explanatory view showing an example of a reliability identification table used for identifying the reliability from a sum of the numbers of times of capacity learning. In FIG. 6, a reliability determination table is a table in which a sum of the numbers of times of capacity learning and a reliability of data used for estimation of a deterioration state are associated with each other. The number of times of capacity learning is a value (a total number) acquired by counting the number of times of capacity learning for a latest predetermined period. The reliability is a value (a value represented as a percentage) set in accordance with the number of times of capacity learning.

For example, in a case where a sum of the numbers of times of capacity learning is equal to or smaller than a threshold value, the reliability is a value corresponding to the number of times of capacity learning (for example, a smaller value as the number of times of capacity learning decreases). In a case where a sum of the numbers of times of capacity learning exceeds a threshold value, the reliability is a constant value. In a case where a configuration is employed in which the reliability (index value) is identified using a sum of squares of ΔSOC of capacity learning data, a reliability identification table in which a sum of squares of ΔSOC and the reliability are associated with each other may be prepared.

### [One Example of Display Screen]

Next, an example of a display screen relating to a deterioration state of the battery 40 displayed on the display part 62 will be described with reference to FIG. 7. FIG. 7 is an explanatory view showing an example of a display screen relating to a deterioration state of the battery 40. As shown in FIG. 7, a deterioration state suggesting image 401 showing a deterioration state of the battery 40, a reliability suggesting image 402 showing reliability of data used for estimation of a deterioration state, a notification image 403 inquiring of a user about presence/absence of execution of a capacity learning operation, an approval acceptance button 404, and time information 405 are displayed on the display part 62.

The deterioration state suggesting image 401 is an image showing a deterioration state of the battery 40 in a graph form (a bar graph form) together with a numerical value representing a percentage. However, the deterioration state suggesting image 401 may be an image displaying only a numerical value representing a percentage or may be an image displaying only a graph.

The reliability suggesting image 402 displays the reliability of data used for estimation of the deterioration state of the battery 40 in a graph form. The reliability is a value identified using the number of times of capacity learning for a latest predetermined period (refer to the reliability identification table shown in FIG. 6). The reliability suggesting image 402 may be an image showing a numerical value representing a percentage instead of a graph or together with a graph.

In FIG. 7, the reliability suggesting image 402 includes an image showing a target value. Accordingly, it is possible to prompt a user to recover the reliability. The target value may be changeable in accordance with the current reliability. Specifically, the target value may be set to be low in a case where the reliability is low and may be set to be high in a case where the reliability is high. Thereby, it is possible to set the target value to a value close to the current reliability, and therefore, it is possible to further prompt a user to recover the reliability.

The notification image 403 is an example of an image showing information requesting an approval for a capacity learning operation. Specifically, the notification image 403 is an image showing a notification indicating that a learning operation is required for recovering the reliability or a notification urging a capacity learning operation. The approval acceptance button 404, for example, accepts whether or not a capacity learning operation is performed via a touch panel of the display part 62.

The time information 405 represents a current time and a predicted time for the next travel. It is possible to indirectly notify a user that a predetermined time (for example, six hours) for performing a capacity learning operation can be secured from the current time and the predicted time for the next travel. A notification indicating that a predetermined time is required for a capacity learning operation may be performed together with the time information 405 or instead of the time information 405. In addition to the contents shown in FIG. 7, for example, a notification indicating that the battery 40 is not fully charged until the learning operation ends may be performed, or a notification indicating that travel of the vehicle 10 is avoided until the learning operation ends may be performed.

According to the diagnosis apparatus 100 of the embodiment described above, in a case where an index value (for example, the number of times of capacity learning) indicating the validness of data used for estimation of a deterioration state of the battery 40 is equal to or smaller than the threshold value, a user is requested to approve a capacity learning operation. Accordingly, a capacity learning operation can be configured not to be performed when it is not intended by a user, and therefore, it is possible to prevent a capacity learning operation from troubling the user. On the other hand, for example, when there is no trouble for a user such as when the user does not use the vehicle 10, a capacity learning operation can be performed. Thereby, the reliability of data used for estimation of the deterioration state of the battery 40 can be improved, and therefore, it is possible to estimate the deterioration state of the battery 40 with high accuracy.

Further, in a case where the parking status of the vehicle 10 satisfies a predetermined condition, the diagnosis apparatus 100 requests a user to perform an approval for a capacity learning operation. Accordingly, when a user is predicted not to use the vehicle 10, a user's approval can be acquired. Thereby, an approval for a capacity learning operation can be acquired at a timing that is optimal for a user such as a timing at which the user does not use the vehicle 10. For this reason, a notification or an operation for acquiring an approval can be configured not to be troublesome for a user.

Further, when requesting a user to perform an approval for a capacity learning operation, the diagnosis apparatus 100 notifies a user of the deterioration state suggesting image 401 (refer to FIG. 7) showing a deterioration state of the battery 40 and the reliability suggesting image 402. Thereby, the user can perceive the deterioration state of the battery 40 and the reliability (accuracy). For this reason, it is possible to prompt the user to perform a capacity learning operation. That is, it is possible to prompt the user to recover the reliability of data used for estimation of the deterioration state of the battery 40 and to improve the accuracy of the estimated deterioration state.

Further, in a case where an index value (for example, the number of times of capacity learning) indicating the validness of data used for estimation of the deterioration state of the battery 40 is equal to or smaller than the threshold value, the diagnosis apparatus 100 of the embodiment requests the charge control part 210 to perform a capacity learning operation. Accordingly, the battery 40 can be charged or discharged in accordance with a capacity learning operation. Thereby, the reliability of data used for estimation of the deterioration state of the battery 40 can be improved, and therefore, it is possible to estimate the deterioration state of the battery 40 with high accuracy.

Further, in a case where the parking status of the vehicle 10 satisfies a predetermined condition, the diagnosis apparatus 100 requests the charge control part 210 to perform a capacity learning operation. Accordingly, the capacity learning operation can be performed when the user is predicted not to use the vehicle 10.

Thereby, the capacity learning operation can be performed when there is no trouble for the user such as when the user does not use the vehicle 10.

Further, in the present embodiment, a capacity learning operation is an operation including a state in which charging/discharging of the battery 40 is performed and a pause state in which charging/discharging is not performed. Thereby, charging/discharging having a large amount of change (ΔSOC) in the charging rate can be performed in a state where the battery 40 is stabilized. Accordingly, the reliability of data used for estimation of the deterioration state of the battery 40 can be improved. Thereby, it is possible to estimate the deterioration state of the battery 40 with high accuracy.

### Modified Example 1

Next, Modified Example 1 of the present embodiment will be described. Although the above embodiment is described using a configuration in which all the functional parts of the diagnosis apparatus 100 according to the present invention are included in the vehicle 10, a configuration in which some or all of the functional parts of the diagnosis apparatus 100 are included in another device (for example, a center server) will be described.

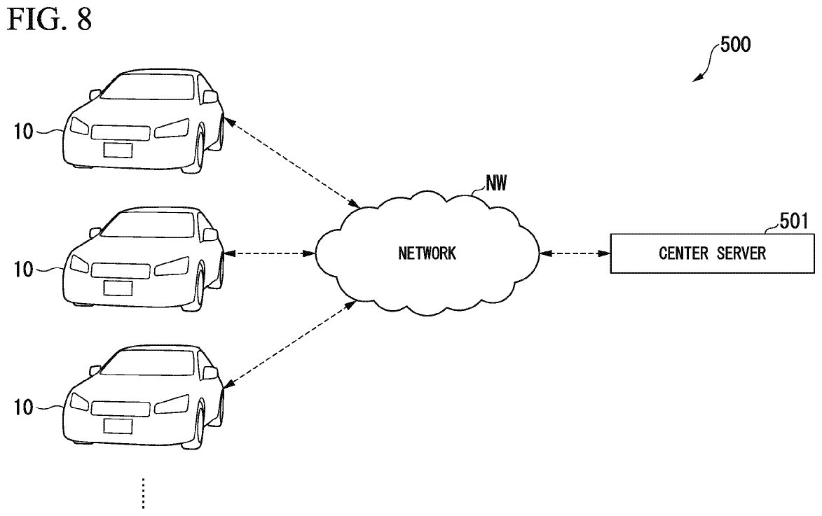

FIG. 8 is an explanatory view showing Modified Example 1 of the present embodiment.

FIG. 8 is an explanatory view showing an example of the configuration of a diagnosis system 500. The diagnosis system 500 is a battery control system that manages a deterioration state and the like of a battery 40 mounted on a vehicle 10. The diagnosis system 500 includes a plurality of vehicles 10 and a center server 501. The vehicle 10 and the center server 501 communicate with each other through a network NW. The network NW, for example, includes the Internet, a WAN (Wide Area Network), a LAN (Local Area Network), a provider device, a radio base station, and the like.

Each of the plurality of vehicles 10 includes a communication device. The communication device includes a radio module used for connecting to a cellular network or a Wi-Fi network. The communication device acquires information indicating an output of a battery sensor 42 and transmits the acquired information to the center server 501 through the network NW shown in FIG. 8. The communication device receives information transmitted from the center server 501 through the network NW. The communication device outputs the received information to the display device 60.

The center server 501 manages information relating to the battery mounted on the vehicle 10 on the basis of information transmitted from the plurality of vehicles 10 (communication devices). Here, the center server 501 may have the functions of the estimation part 301, the derivation part 302, the approval part 303, the output part 304, the acceptance part 305, the request part 306, and the acquisition part 307 shown in FIG. 3.

Specifically, the center server 501 may receive information indicating an output of the battery sensor 42 from the communication device of the vehicle 10 and estimate the deterioration state of the battery 40 on the basis of the information (the estimation part 301). The center server 501 may receive data used for estimation of the deterioration state from the communication device of the vehicle 10 and derive an index value indicating the validness of data used for estimation of the deterioration state on the basis of the received data (derivation part 302).

In a case where the derived index value is equal to or smaller than a predetermined value, the center server 501 may output (transmit) information requesting a user's approval to the vehicle 10 (the approval part 303 and the output part 304). The center server 501 may accept a user's input through the vehicle 10 (the acceptance part 305). In a case where the derived index value is equal to or smaller than a predetermined value, the center server 501 may transmit information for requesting the charger 200 to perform a capacity learning operation to the vehicle 10 (the request part 306). The center server 501 may acquire information indicating a parking status of the vehicle from the vehicle (the acquisition part 307).

In Modified Example 1, the center server 501 may include at least some of the functional parts of the diagnosis apparatus 100. Specifically, for example, the center server 501 may include only the estimation part 301 or may include the estimation part 301 and the derivation part 302. In such a case, functions not included in the center server 501 may be included in the vehicle 10.

The center server 501, for example, may receive information relating to the deterioration state of the battery (an index value or information indicating a deterioration state) and use status information (a battery temperature, a travel load, an average SOC, the number of times of charging, and the like) from each vehicle 10 and calculate and manage an average value of each value thereof for the plurality of vehicles 10. The vehicle 10 may receive an average value calculated by the center server 501 and display the received average value and information relating to the battery of the vehicle on the display part 62 in association with each other.

Thereby, a user can perceive the reliability and the deterioration state of the battery 40 of the vehicle by comparing them with average values of other vehicles 10. In a case where the reliability of data used for estimation of the deterioration state of the battery 40 is low, by comparing the reliability with an average thereof for the other vehicles 10, it is possible to further prompt the user to recover the reliability.

### Modified Example 2

Next, Modified Example 2 of the present embodiment will be described. Although the embodiment is described using a configuration in which information indicating the parking status of the vehicle 10 is acquired from the travel history of the navigation device mounted on the vehicle 10, a configuration in which the information is acquired from a schedule of another device (for example, a communication terminal device such as a smartphone) will be described.

In Modified Example 2, the vehicle 10 includes a communication device. This communication device is communicatively connected to a communication terminal device (for example, a smartphone, a tablet terminal, a laptop PC, or the like) in a wired or wireless manner. An application of a scheduler used for managing a user's schedule is installed in the communication terminal device. By receiving user's schedule information from the communication terminal device, the communication device of the vehicle 10 can acquire information of a scheduled parking time of the vehicle 10. Thereby, a capacity learning operation can be performed in a case where a charge time that is equal to or longer than a predetermined time (for example, 6 hours) can be secured.

Further, for example, the communication device of the vehicle 10 refers to user's schedule information received from the communication terminal device and can be configured not to perform a capacity learning operation, for example, in a case where a travel for a long movement distance is scheduled the next day. In this way, by using user's schedule information, a capacity learning operation can be performed in accordance with a user's schedule.

While embodiments of the invention have been described and shown above, it should be understood that these are exemplary of the invention and are not to be considered as limiting. Additions, omissions, substitutions, and other modifications can be made without departing from the scope of the present invention.

What is claimed is:

1. A diagnosis apparatus comprising:
an estimation part that estimates a deterioration state of a secondary battery based on an output of a sensor which is attached to the secondary battery that supplies electric power for driving a vehicle to travel;
a derivation part that derives an index value indicating validness of data used for estimation of the deterioration state;
an output part that outputs information; and
an approval part that allows the output part to output information requesting an approval for performing a specific charging/discharging operation using an external charger which supplies electric power to the secondary battery in a case where the index value that is derived by the derivation part is equal to or smaller than a predetermined value.

2. The diagnosis apparatus according to claim 1, further comprising:
an acceptance part that accepts a user's input,
wherein the approval part performs a process for performing the specific charging/discharging operation based on the user's input that is accepted by the acceptance part.

3. The diagnosis apparatus according to claim 1,
wherein the derivation part derives the index value based on a number of times of acquiring the output of the sensor as the data used for estimation performed by the estimation part.

4. The diagnosis apparatus according to claim 1,
wherein the derivation part derives the index value based on an amount of change in a charging rate of the secondary battery changed in accordance with charging/discharging of the secondary battery.

5. The diagnosis apparatus according to claim 1, further comprising:
an acquisition part that acquires information indicating a parking status of the vehicle,
wherein the approval part allows the output part to output the information requesting the approval in a case where the parking status indicated by the information that is acquired by the acquisition part satisfies a predetermined condition.

6. The diagnosis apparatus according to claim 1,
wherein the approval part allows the output part to output the index value and information indicating the deterioration state of the secondary battery when allowing the output part to output the information requesting the approval.

7. A diagnosis method performed using a computer mounted on a vehicle, the diagnosis method comprising:
estimating a deterioration state of a secondary battery based on an output of a sensor which is attached to the secondary battery that supplies electric power for driving the vehicle to travel;
deriving an index value indicating validness of data used for estimation of the deterioration state; and
allowing an output part to output information requesting an approval for performing a specific charging/discharging operation using an external charger which supplies electric power to the secondary battery in a case where the derived index value is equal to or smaller than a predetermined value.

8. A non-transitory computer-readable recording medium including a program causing a computer mounted on a vehicle to execute:
estimating a deterioration state of a secondary battery based on an output of a sensor which is attached to the secondary battery that supplies electric power for driving the vehicle to travel;
deriving an index value indicating validness of data used for estimation of the deterioration state; and
allowing an output part to output information requesting an approval for performing a specific charging/discharging operation using an external charger which supplies electric power to the secondary battery in a case where the derived index value is equal to or smaller than a predetermined value.
